(19) United States
(12) Patent Application Publication
(10) Pub. No.: US 2002/0175062 A1
(43) Pub. Date: Nov. 28, 2002

(54) Switching device for a pump for administering a fluid for detecting the switching device

(76) Inventors: Philip Etter, Ittigen (CH); Susanne Wyss-Lanz, Affoltern i.E. (CH)

Correspondence Address: David E. Bruhn, DORSEY & WHITNEY LLP, Suite 1500, 50 South Sixth Street, Minneapolis, MN, 55402-1498, US

(21) Appl. No.: 10/132,941

(22) Filed: Apr. 26, 2002

(30) Foreign Application Priority Data
May 3, 2001 (DE) DE 101 21 508.8

(51) Int. Cl. H01H 9/00

(52) U.S. Cl. 200/310

(57) ABSTRACT

The invention relates to a switching device for a pump, the switching device including a switch and an illuminating device, wherein a minimum force must be applied to the switch before a switching signal is generated, and encompasses a method for operating the illuminating device so that it emits different light signals depending on at least one of a switching state of the switch and an operational state of the pump.

### PRIORITY CLAIM

This application claims priority to German Application DE 101 21 508.8, filed May 3, 2001, which is hereby incorporated in its entirety.

### BACKGROUND

The present invention relates to a switching device for a pump for administering a fluid, in particular for a peristaltic pump with which different medicines, such as antibiotics, pain relievers, medicines for chemotherapy, etc., can be administered, and to a method for directing the switching device. The switching device is preferably intended to serve as a bolus provider in that it actuates the pump to provide a bolus.

Switching devices are known, including switching devices such as the device distributed under the name Cordette, made by the firm Switchcraft, which can be connected to a pump by means of a cable and a plug. While well-suited for their intended purposes, such known switching devices fail to address certain problems, including use by older people, in particular those whose sight is impaired.

### SUMMARY

The present invention proposes a switching device for a pump for administering a fluid, which enables the pump to be operated confidently.

In one embodiment, the present invention is a switching device for a pump, the switching device including a switch and an illuminating device, wherein a minimum force must be applied to the switch before a switching signal is generated.

In one embodiment, the present invention is a method for operating an illuminating device associated with a switching device for controlling a pump so that the illuminating device emits different light signals depending on at least one of a switching state of the switch and an operational state of the pump.

In one embodiment, the present invention comprises a switching device for a pump, the switching device including a switch and an illuminating device, wherein a minimum force must be applied to the switch before a switching signal is generated, and wherein the illuminating device emits different light signals depending on at least one of a switching state of the switch and an operational state of the pump.

In one embodiment, the present invention comprises a system for administering a fluid comprising a pump, a switching device operably coupled to the pump, and an illuminating device operably coupled to at least one of the pump and the switching device.

The switching device in accordance with the invention for a pump for administering a fluid comprises a switch, wherein an illuminating device is preferably provided on the switch in accordance with a first embodiment of the invention. The illuminating device can either be integrated in the switching element itself or arranged in the vicinity of the switching element, e.g., around a push-button. Combinations of different illuminating elements can also be used. An operator can thus locate the switch quickly in the dark or in poor visibility, and also therefore quickly trigger the desired action of the pump, e.g., releasing a bolus, i.e., briefly releasing a greater quantity of a medicine, e.g., a pain reliever in the case of analgesic therapy, where the pump should be programmed appropriately.

In accordance with another embodiment of the invention, which can be used independent of or in combination with the first embodiment, a switching device for a pump for administering a fluid comprises a switch which comprises a particular pressure point, i.e., the switch has to be pressed with a particular, defined minimum force, which can be set or predetermined, before the switch generates a switching signal, e.g., establishes a contact or triggers an action. In this way, the operator can see whether the switch has been activated, e.g., whether a bolus has been released or not. The switch can also thus be prevented from being inadvertently activated by being gently touched, or by the switch being inadvertently pressed by being dropped or put down. In addition, there is a feedback with respect to activating the switch which the operator can feel, i.e. an operator can feel that the switch has been actively pressed, which is not the case with switches which can be pressed without appreciable resistance, which often leads to uncertainty for the operator. Preferably, a pressure point which can be felt is provided for or by the switch. In addition, an acoustic element can be provided, to emit an acoustic signal—e.g., a click—in the event, for example, of a particular pressure position of the switch.

The switch is preferably formed as a push-button which can advantageously be pushed against a pre-tensioning element, e.g., a spring, such that a defined resistance can be set or established via the pre-tensioning element. The switch can, however, also be formed as a flip switch, slide switch or any other suitable switching element.

Advantageously, a minimum distance is provided for the switch, along which the switch has to be moved before a switching signal is generated, e.g., before a contact is established or an action triggered. Thus, for example, a minimum distance of approximately 1 mm to 4 mm, advantageously 2 mm, can be provided in a push switch, wherein the switch has to be pushed by at least said distance before a contact is established. A minimum distance for activating the switch can likewise be provided in a slide switch, flip switch or other switching element, before a contact is established. Such an embodiment increases operational certainty and reduces the risk of erroneously operating the switch, e.g., by inadvertently gently touching it.

The switch is particularly preferably provided in a recess of the switching device, which can secure the switch against being unintentionally activated or pressed in. The recess can be formed, for example, by a protruding element around the switch, wherein the switch should still be securely and easily operable using a finger. One or more protruding protective elements could also be arranged in the vicinity of the switch or around the switch, to largely rule out the possibility of the switch being inadvertently activated.

The illuminating device can be formed, for example, by one or more light-emitting diodes (LEDs), light bulbs or other light-emitting elements which can actively emit light. Advantageously, at least two different illuminating elements are used on the switching device, and/or also on the pump, which can, for example, have different colours, in order, for example, to be able to indicate different states. Thus, for example, a first illuminating element can be provided for emitting green light which simplifies locating the switch, and a second illuminating element can be provided for emitting red light which serves to indicate correct operation of the switch. However, a signal with respect to correct operation and/or different operational states can also be emitted by a single illuminating element through different circuits, e.g., by increasing or reducing the brightness of the illuminating element or by particular blinking signals when a particular operational state is reached and/or a particular action is triggered. Equally, acoustic signals can also be emitted for particular operational states of the switching device or of the pump. Passive illuminating elements can also be advantageously provided, such as, for example, fluorescent surfaces, which may be located on the switch or in the vicinity of the switch.

If active light-emitting elements—such as LEDs—are used, then it is advantageous to provide a power supply in the switching device itself, such as batteries or accumulators or other energy-storing elements which can also be charged as appropriate, e.g., via an external charger or via the pump. It is equally possible to draw power from the pump.

If active light-emitting elements are used, a second switching element is preferably provided, with which the light-emitting elements can be switched on or off, for example to reduce the power consumption of the light-emitting elements when there is sufficient light, or to switch them off completely. Advantageously, a light-sensitive element can also be provided, with which the brightness or the switching state of the active light-emitting elements can be automatically set. To this end, a control system can advantageously be provided for controlling or selecting, for example, the brightness, switching-on time or a blinking pattern, for example, a time out in the range of 1 to 30 seconds, preferably 3 to 20 seconds, can be set.

Advantageously, the switching device is connected to the pump via a cable and a plug, preferably with a cable cleat, such that the switching device is formed as a separate unit and can be connected to and detached from the pump.

The switching device preferably comprises a mounting, such as a clip, a plug element or the like, with which the switching device can be fixed to an object, such as a shirt or other article of clothing.

The invention further relates to a system comprising a pump and a switching device, comprising one or more of the features described above.

One embodiment of the method in accordance with the present invention comprises directing an illuminating device associated with a switching device to selectively control the light emitted by the illuminating device. In one embodiment, the illuminating device comprises at least one light-emitting element associated with the switching device which is directed such that it emits a different light signal, e.g., changes the brightness, emits a particular blinking pattern or changes the time intervals of a blinking signal, depending on a particular operational state, e.g., the switching state of the switch, whether the switch is pressed, or an operational state of the pump.

### BRIEF DESCRIPTION OF THE DRAWING

FIG. 1 depicts an embodiment of a system and switching device in accordance with the present invention.

### DETAILED DESCRIPTION

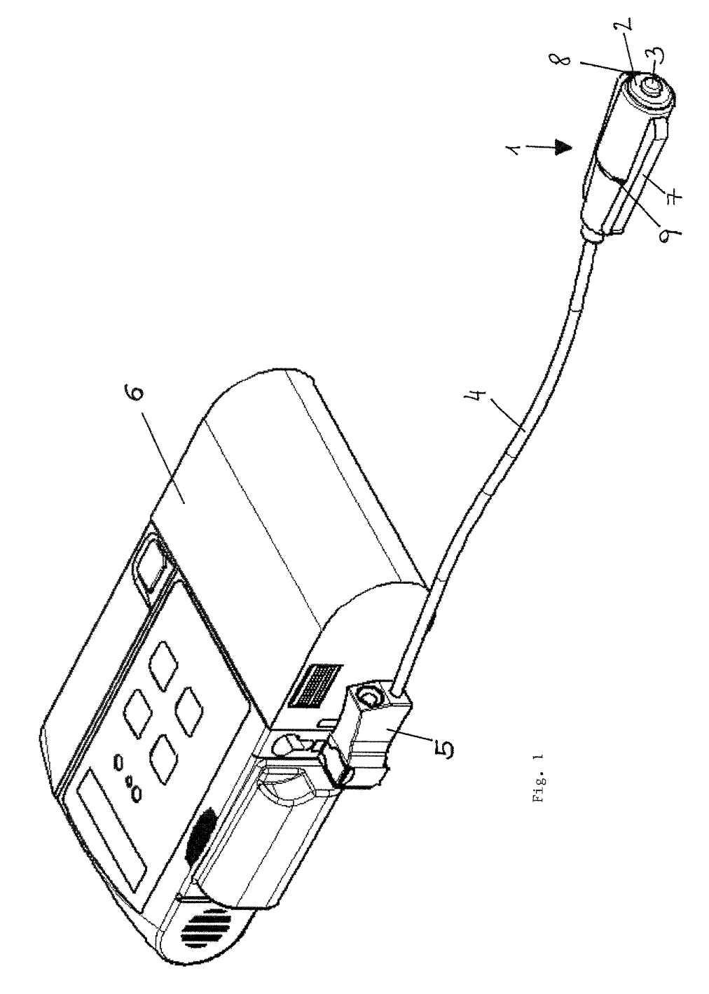

FIG. 1 shows a switching device 1 comprising a push switch 2 in which an LED 3 is provided. The LED 3 can be switched on and off by the LED switch 7 arranged on the switching device 1, and enables the switch 2 to be confidently located when it is switched on. A fluorescent layer 8 is arranged annularly around the push button 2, said layer 8 likewise helping the switch 2 to be simply and confidently located. The push button 2 is pre-tensioned from the inner side of the switching device 1, outwardly by a spring (not shown) and has to be pushed in by a defined distance, e.g., 2 mm, against the force of the spring before a contact is established by the switch 2, wherein the signal triggered by pushing in the switch 2 is transmitted to the pump 6 via the cable 4 which is connected to the pump 6 by the plug 5. Thus, for example, the switch 2 can simply establish a contact between two separate conductors arranged in the cable 4 to, for example, trigger the pump 6 to release a bolus.

A spring setting element 9 is provided on the switching device 1 in the form of a rotatable ring which preferably can be latched in different positions, such that the spring force which has to be overcome when pushing the switch 2 can be set using the spring setting element 9. To this end, turning the spring setting element 9 can, for example, further tense or relax a spiral spring, in order to set a desired pressure point of the switch 2.

In the foregoing description a preferred embodiment of the invention has been presented for the purpose of illustration and description. It is not intended to be exhaustive or to limit the invention to the precise form disclosed. Obvious modifications or variations are possible in light of the above teachings. The embodiment was chosen and described to provide the best illustration of the principals of the invention and its practical application, and to enable one of ordinary skill in the art to utilize the invention in various embodiments and with various modifications as are suited to the particular use contemplated. All such modifications and variations are within the scope of the invention as determined by the appended claims when interpreted in accordance with the breadth they are fairly, legally, and equitably entitled.

What is claimed is:

1. A switching device for a pump for administering a fluid, comprising a switch and an illuminating device.

2. The switching device as set forth in claim 1, wherein a minimum force must be applied to said switch before a switching signal is generated.

3. The switching device as set forth claim 1, wherein said illuminating device is operably coupled to said switch.

4. The switching device as set forth in claim 1, wherein said switch is one of a switch group comprising a push-button switch, a slide switch and a flip switch.

5. The switching device as set forth in claim 1, wherein said switch is formed such that it has to be operated a minimum switching distance before a switching signal is generated, wherein said minimum switching distance is approximately 1 to 4 mm.

6. The switching device as set forth in claim 1, wherein said switch is arranged in a recess.

7. The switching device as set forth in claim 1, wherein said illuminating device is an active light-emitting element.

8. The switching device as set forth in claim 1, said illuminating device comprising at least two illuminating elements, one emitting light of one wavelength and the other emitting light of another wavelength.

9. The switching device as set forth in claim 1, further comprising a passive illuminating element.

10. The switching device as set forth in claim 1, further comprising at least one energy-storing element operably coupled to said switching device.

11. The switching device as set forth in claim 7, further comprising a switching device for switching the active light-emitting element.

12. The switching device as set forth in claim 1, further comprising a control system for controlling the illuminating device.

13. The switching device as set forth in claim 1, further comprising a cable and a plug connected to said switching device.

14. The switching device as set forth in claim 1, wherein said switching device further comprises a mounting.

15. A system for the administration of a fluid comprising a pump, a switching device operably coupled to the pump and an illuminating device operably coupled to at least one of the pump and the switching device.

16. A switching device for a pump for administering a fluid, comprising a switch that has to be pressed with a minimum force before a switching signal is generated.

17. The switching device as set forth claim 16, further comprising an illuminating device associated with said switch.

18. The switching device as set forth in claim 16, wherein said switch is one of a push-button switch, a slide switch and a flip switch.

19. The switching device as set forth in claim 16, wherein said switch is formed such that it has to be operated a minimum switching distance before a switching signal is generated, wherein said minimum switching distance is approximately 1 to 4 mm.

20. The switching device as set forth in claim 16, wherein said switch is arranged in a recess.

21. The switching device as set forth in claim 17, wherein said illuminating device is an active light-emitting element.

22. The switching device as set forth in claim 16, further comprising at least two illuminating elements.

23. The switching device as set forth in claim 16, further comprising passive illuminating elements.

24. The switching device as set forth in claim 16, further comprising at least one energy-storing element.

25. The switching device as set forth in claim 21, wherein a second switching device is provided for switching the at least one active light-emitting element.

26. The switching device as set forth in claim 21, wherein a control system is provided with which at least one active light-emitting element can be directed such that it emits different light signals for different operational states.

27. The switching device as set forth in claim 16, wherein a cable and a plug is connected to said switching device.

28. The switching device as set forth in claim 16, wherein said switching device comprises a mounting.

29. A system for the administration of a fluid comprising a pump and a switching device wherein a predetermined minimum force has to be applied to the switching device to generated a signal.

30. A method for directing at least one light-emitting element of a switching device comprising a switch for a pump, wherein said at least one light-emitting element emits different light signals depending on at least one of a switching state of said switch and an operational state of said pump.

31. The method as set forth in claim 30, wherein said different light signals are blinking signals having different time intervals.

32. The method as set forth in claim 30, wherein said different light signals exhibit a different brightness.

33. The switching device as set forth in claim 1, wherein said illuminating device is carried on said switch.

34. The switching device as set forth in claim 5, wherein said minimum switching distance is approximately 2 mm.

35. The switching device as set forth in claim 1, wherein said switch is in the vicinity of protruding protective elements.

36. The switching device as set forth in claim 7, wherein said active light-emitting element is a light-emitting diode.

37. The switching device as set forth in claim 7, wherein said illuminating device is a light bulb.

38. The switching device as set forth in claim 9, said passive illuminating element comprising fluorescent elements.

39. The switching device as set forth in claim 7, further comprising a control system is provided to control the light-emitting element such that it emits different light signals for different operational states.

40. The switching device as set forth in claim 19, wherein said minimum switching distance is approximately 2 mm.
